(19) United States
(12) Patent Application Publication
(10) Pub. No.: US 2016/0175782 A1
(43) Pub. Date: Jun. 23, 2016

(54) IN-BOTTLE WINE AERATOR

(71) Applicant: WINE REVEAL, LLC, San Luis Obispo, CA (US)

(72) Inventor: Michael H. Lau, San Luis Obispo, CA (US)

(21) Appl. No.: 14/909,953

(22) PCT Filed: Aug. 6, 2014
(86) PCT No.: PCT/US2014/049997

§ 371 Date: Feb. 3, 2016

Related U.S. Application Data
(60) Provisional application No. 61/863,838, filed on Aug. 8, 2013.

(51) Int. Cl. B01F 3/04; B01F 5/04; B01F 5/06

(52) U.S. Cl. CPC B01F 3/04794; B01F 5/0655; B01F 5/0428; B01F 5/0652

(57) ABSTRACT

An aerator for use substantially within the neck of a bottle is disclosed. The aerator includes a body having a first end, a second end, and a pouring channel for egress of liquid from the bottle. The pouring channel can vary in cross-sectional area from the first end to the second end. The pouring channel can have a first cross-sectional area at the first end, a second cross-sectional area at an area intermediate the first end and the second end, with the first cross-sectional area being larger than the second cross-sectional area. The aerator may further include an air passage channel substantially parallel to the pouring channel, the air passage channel configured to allow air to enter the bottle and an aerator channel configured to allow air to enter the pouring channel at the second cross-sectional area.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Application No. 61/863,838, filed Aug. 8, 2013. The disclosure of the above-referenced application is hereby expressly incorporated by reference in its entirety.

### BACKGROUND OF THE INVENTION

1. Field of the Invention

This application relates to the field of aeration of liquids. More particularly, this application relates to aeration of liquids using an in-bottle aerator.

2. Description of the Related Art

Many wine consumers often like to aerate, or oxidize, their wine to enhance its flavor prior to drinking. Existing aerators are typically extensions of the wine bottle and must be purchased by the consumer separately as an accessory. An in-bottle aeration system would allow consumers to more easily aerate wine as it is poured without requiring a separate accessory.

Wine aerators are in general best suited for young red wines that are high in tannins such as mixes, cabernets, syrahs, or zinfandels. Positive aeration results have been achieved using aerators that aerate the wine as much as a possible.

### SUMMARY OF THE INVENTION

Embodiments provide low cost, aesthetically-pleasing wine aerators. These aerators are preferably located within the bottle and effectively mix and soften the mouth feel of liquids, such as wines.

One embodiment of an in-bottle wine aerator is a Venturi-style in-bottle aerator. In this embodiment, wine enters the constricted section where it speeds up, decreasing the fluid pressure. As pressure is decreased, air is drawn in and mixes with the wine. The wine then enters an expansion nozzle, resulting in greater mixing of air with the wine.

Another embodiment is a corkscrew-shaped in-bottle aerator. The corkscrew shape increases the turbulence of the wine as it exits the bottle. The increased turbulence results in air mixing with the wine as it exits the bottle, aerating the wine.

Yet another embodiment is a tapered turbulence in-bottle aerator. The in-bottle aerator induces turbulent flow of the wine as it is poured from the bottle. The turbulent flow of the wine aerates the wine as it is poured.

In a first aspect, an aerator for use substantially within the neck of a bottle, includes a body having a first end, a second end, and a pouring channel for egress of liquid from the bottle. The pouring channel may vary in cross-sectional area from the first end to the second end. The pouring channel may have a first cross-sectional area at the first end, a second cross-sectional area at an area intermediate the first end and the second end, the first cross-sectional area being larger than the second cross-sectional area. The aerator may further include an air passage channel substantially parallel to the pouring channel, the air passage channel configured to allow air to enter the bottle and an aerator channel configured to allow air to enter the pouring channel at the second cross-sectional area.

In some embodiments, the aerator may further include at least one flexible sealing surface on an exterior surface of the body such that the body can seal within a neck of the bottle and act as a stopper to prevent liquid from passing between the body and an interior surface of the bottle, the sealing surface having a diameter greater than an external diameter of the body. In some embodiments, the diameter of the at least one flexible sealing surface is 20.5 mm and the external diameter of the body is 17 mm. In some embodiments, the aerator includes five sealing surfaces. In some embodiments, the aerator is made from one or more of silicone, acrylic, stainless steel, food-grade high-density polyethylene, and polypropylene. In some embodiments, the air passage channel can extend further into the bottle beyond one of the first and the second end of the body. In some embodiments, the air passage channel has a smaller cross-sectional area than the first cross-sectional area of the pouring channel. In some embodiments, the air passage channel has a diameter of 1 mm. In some embodiments, the second cross-sectional area is a minimum cross-sectional area of the pouring channel. In some embodiments, the aerator channel bisects the air passage channel. In some embodiments, the aerator channel is substantially orthogonal to the pouring channel. In some embodiments, a flow of liquid through the pouring channel is approximately 50 milliliters per second.

In another aspect, an aerator for use substantially within the neck of a bottle includes a body having a first end, a second end, a pouring channel for egress of liquid from the bottle, an air passage channel for ingress of air to the bottle, and an aerator channel for ingress of air to the pouring channel, the pouring channel having at least one of converging section and at least one diverging section.

In yet another aspect, an aerator for use substantially within the neck of a bottle includes a body having a first end, a second end, and a pouring channel for egress of liquid from the bottle, the pouring channel varying in cross-sectional area from the first end to the second end. The pouring channel may have a first cross-sectional area at the first end and taper to a second cross-sectional area at a first point intermediate the first end and the second end, the second cross-sectional area at the first point transitioning without taper to a third cross-sectional area larger than the second cross-sectional area. In some embodiments, the first cross-sectional area and the third cross-sectional area are approximately equal. In some embodiments, the second cross-sectional area is a minimum cross-sectional area of the pouring channel. In some embodiments, the aerator may further include an aerator channel passing through the body of the aerator from an external surface of the body to the pouring channel, the aeration channel intersecting the pouring channel at the second cross-sectional area. In some embodiments, the aerator may further include at least one flexible sealing surface on an exterior surface of the body such that the body can seal within the neck of the bottle and act as a stopper to prevent liquid from passing between the body and an interior surface of the bottle, the sealing surface having a diameter greater than an external diameter of the body. In some embodiments, the diameter of the at least one flexible sealing surface is 20.5 mm and the external diameter of the body is 17 mm. In some embodiments, the aerator is made from one or more of silicone, acrylic, stainless steel, food-grade high-density polyethylene, and polypropylene.

### BRIEF DESCRIPTION OF THE DRAWINGS

FIG. 1 is a perspective view of an in-bottle aerator, according to one embodiment.

FIG. 2 is a cross-sectional view of the aerator shown in FIG. 1.

FIG. 3 is a side plan view of the aerator shown in FIG. 1.

FIG. 4 is a second side plan view of the aerator shown in FIG. 1.

FIG. 5 is a view looking through the aerator shown in FIG. 1 from a proximal end of the aerator.

FIG. 6 is a perspective view of an in-bottle aerator, according to another embodiment.

FIG. 7 is a cross-sectional view of an in-bottle aerator, according to a third embodiment.

FIG. 8 is a perspective view of an in-bottle aerator, according to a fourth embodiment.

### DETAILED DESCRIPTION OF THE PREFERRED EMBODIMENTS

The features, aspects and advantages of the present invention will now be described with reference to the drawings of several embodiments, which are intended to be within the scope of the invention herein disclosed and disclosed in U.S. Provisional Patent Application No. 61/863,838, filed Aug. 8, 2013. The disclosure of the above-referenced application is hereby expressly incorporated by reference in its entirety. These and other embodiments will become readily apparent to those skilled in the art from the following detailed description of the embodiments having reference to the attached figures, the invention not being limited to any particular embodiment(s) disclosed.

While some “aerators” are no more than a filter that the wine flows through, more effective aerators would make use of the Venturi effect to actively mix air with the wine by decreasing the wine's pressure with a nozzle. The resultant low pressure produced by flow through the nozzle pulls air into the nozzle through a port located just after the nozzle. Once the air is introduced to the wine, the mixture flows through an expanding nozzle that creates turbulence and further mixes it.

Many current aerators are injection molded, but some are made from silicon, cast acrylic, and even stainless steel and almost all current aerators are external of the wine bottle. To offer a more convenient solution, the aerator can be designed to fit within standardized corked bottles of different shapes and sizes.

### Venturi Design

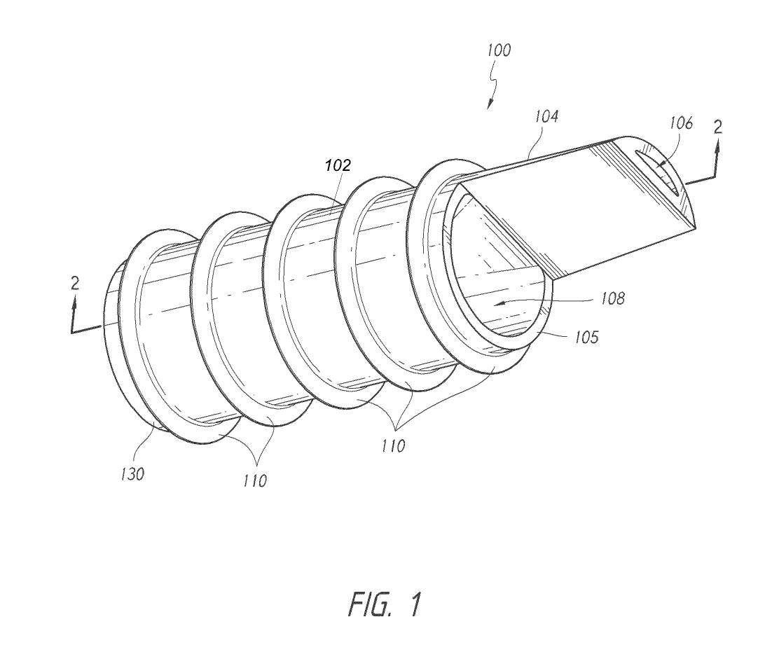

One embodiment of the in-bottle wine aerator 100, shown in FIG. 1, comprises a cylindrical body 102. The cylindrical body 102 defines a pouring channel 108 that is preferably formed in the shape of a nozzle, as will be discussed in greater detail below. The body 102 preferably also defines an air passage 106 that is separated from the pouring channel 108. In some embodiments, the air passage 106 has an internal diameter of approximately 1 mm. In some embodiments, the air passage 106 has an internal diameter between approximately 0.25 mm to approximately 3 mm, between approximately 0.5 mm to approximately 2 mm, and between approximately 0.75 mm to approximately 1.25 mm. Desirably, the air passage 106 runs longitudinally through the body 102 parallel to the pouring channel 108. In some embodiments, an air passage extension member 104 extends from one end of the body 102. In some embodiments, the air passage extension member 104 extends approximately 17 mm from one end of the body 102. In other embodiments, the air passage extension member 104 may extend between approximately 8 mm and approximately 30 mm from one end of the body 102, between approximately 10 mm and approximately 25 mm from one end of the body 102, or between approximately 15 mm and approximately 20 mm from one end of the body. Preferably, the aerator 100 is inserted into a wine bottle with the air passage extension member 104 extending into the bottle to create a vacuum to incorporate air into the bottle for flow. In some embodiments, including the illustrated embodiment, the length of the body 102 is approximately 40 mm. In other embodiments, the length of the body 102 may be between approximately 20 mm and approximately 60 mm, between approximately 25 mm and approximately 55 mm, between approximately 30 mm and approximately 50 mm, or between approximately 35 mm and approximately 45 mm.

A plurality of rib members 110 may extend from the external surface of the body 102 to provide a gripping surface with the interior of the neck of the wine bottle to securely hold the aerator 100 in place within the bottle. The rib members 110 desirably grip the interior surface of the neck of the wine bottle such that the aerator 100 can act as a stopper and direct all flow of liquid through the pouring channel 108. The cylindrical body 102 is preferably shaped such that the body 102 can fit tightly within the neck of a standard corked wine bottle. In other embodiments, the aerator 100 may be formed in different sizes and shapes to fit in lager bottles, such as Magnums or larger bottles. In some embodiments, the body 102 may the diameter and length of the body 102 may vary so that the body 102 can fit securely within wine bottles having varying neck diameters and lengths. Preferably, the aerator 100 has a diameter such that it will securely fit within wine bottles having a range of internal diameters of 19 mm to 21 mm. Preferably, the body 102 of the aerator 100 has an external diameter of approximately 17 mm. In some embodiments, the body 102 has an external diameter between approximately 10 mm and 25 mm, between approximately 12 mm and 22 mm, and between approximately 15 mm and 19 mm. In some embodiments, the external diameter of the body 102 may be larger or smaller to fit within wine bottles having smaller or larger neck diameters. Desirably, the diameter of each of the rib members 110 is approximately 20.5 mm. In some embodiments, the diameter of each of the rib members 110 is between approximately 10 mm to 30 mm, between approximately 15 mm to 25 mm, and between approximately 18 mm to 22 mm. Desirably, the cross-sectional area of the aerator 100 at the widest point (through one of the rib members 110) is approximately 126 mm̂2. In some embodiments, the cross-sectional area of the aerator 100 at the widest point (through one of the rib members 110) is between approximately 50 mm̂2 and 200 mm̂2, between approximately 75 mm̂2 and approximately 150 mm̂2, or between approximately 100 mm̂2 and approximately 135 mm̂2. As discussed above, preferably the rib members 110 grip the interior of the wine bottle and are flexible such that the aerator 102 can fit within wine bottle necks having a diameter larger than the diameter of the body 102 and smaller than the diameter of the rib members 110.

The aerator 100 may be formed from any material safe for use with food or drink that will not “leak” or “leach” into the food or drink. For example, the aerator 100 may be made from silicone rubber, case acrylic, stainless steel, or polymers such as food grade high-density polyethylene (HDPE) and polypropylene (PP). In some embodiments, the aerator 100 is injection molded but other manufacturing methods may also be used.

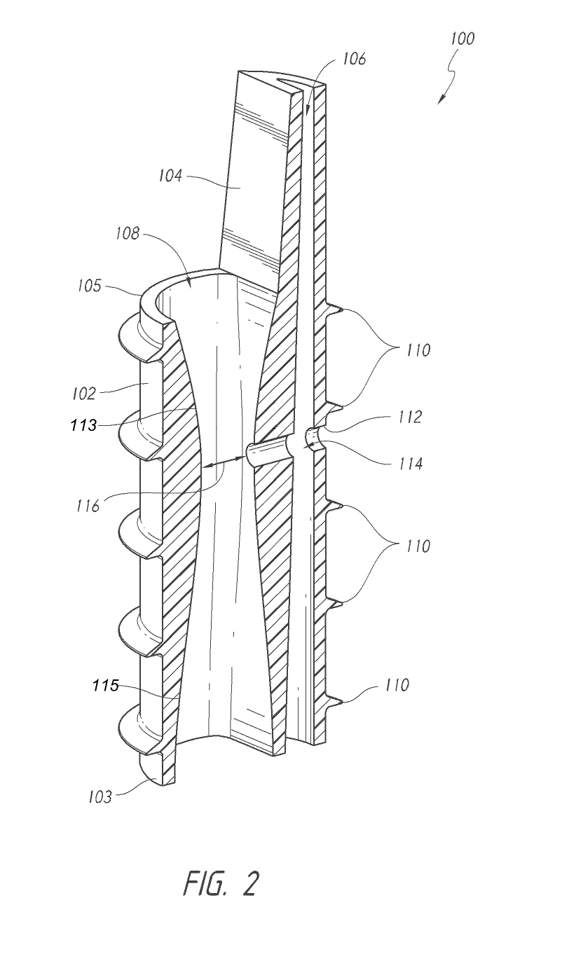

FIG. 2 illustrates a cross-section of the in-bottle aerator 100 illustrated in FIG. 1. The pouring channel 108 is preferably a nozzle-shaped converging and diverging passage having a cross-sectional area that varies along the length of pouring channel 108. The nozzle shape of pouring channel 108 controls the flow characteristics of the fluid as it passes through the passage 108 due to the Venturi effect. A proximal end 105 of the pouring channel 108 narrows or converges to a throat 116 in a converging section 113 before expanding or diverging to a wider cross-sectional area at the distal end 103. Wine or other fluid enters the aerator 100 at the proximal end 105 in the pouring channel 108 and the flow area narrows along the pouring channel 108. Desirably, the pouring channel 108 narrows from the proximal end 105 to the throat along a length of approximately 14 mm. In other embodiments, the pouring channel 108 narrows from the proximal end 105 to the throat along a length of between approximately 5 mm to approximately 25 mm, between approximately 8 mm to approximately 20 mm, or between approximately 12 mm to approximately 16 mm. In other embodiments, the converging section 113 may be longer or shorter depending on the size of the wine bottle and the aerator 100 and the characteristics of the fluid. Desirably, a diameter of the pouring channel 108 at the proximal end 105 is approximately 10 mm. In some embodiments, a diameter of the pouring channel 108 at the proximal end 105 may be between approximately 3 mm and approximately 20 mm, approximately 5 mm and approximately 15 mm, or approximately 8 mm and approximately 12 mm. As the fluid passes through the converging section 113 before entering the throat 116, the fluid accelerates causing the pressure of the fluid to decrease. At the throat 116, or the point of minimum cross-sectional area of the pouring channel 108, the velocity of the fluid has increased and the pressure decreased. In some embodiments, including the illustrated embodiment, the diameter of the pouring channel 108 at the throat 116 is approximately 5.5 mm. In some embodiments, the diameter of the pouring channel 108 at the throat 116 may be between approximately 2 mm and approximately 15 mm, approximately 3 mm and approximately 10 mm, or approximately 4 mm and approximately 7 mm.

Desirably, an opening 112 defines an aeration passage 114 that allows air and oxygen to be sucked into the passage 108 and mix with the fluid passing through the passage 108. In some embodiments, including the illustrated embodiment, the diameter of the aeration passage 114 is approximately 2 mm. In some embodiments, the diameter of the aeration passage 114 is between approximately 0.5 mm to approximately 5 mm, between approximately 1 mm to approximately 4 mm, and between approximately 1.25 mm to approximately 2.5 mm. In some embodiments, the length of the aeration passage 114 from the opening 112 to the throat 116 is approximately 7.5 mm. In some embodiments, the length of the aeration passage 114 from the opening 112 to the throat 116 is between approximately 4 mm to approximately 15 mm, between approximately 5 mm to approximately 10 mm, or between approximately 6 mm to approximately 9 mm. The aeration passage 114 desirably intersects the pouring channel 108 at the throat 116. Air and oxygen will be pushed into the pouring channel 108 because the air pressure outside the channel is greater than the pressure of the fluid. This process causes air and oxygen to mix with the fluid as it is being poured. As the fluid enters the diverging section 115 of the pouring channel 108, the fluid decelerates causing the pressure of the fluid to increase and allowing the fluid to be easily poured from the bottle at the distal end 103 of the pouring channel 108. In some embodiments, the pouring channel 108 diverges from the throat to the distal end along a length of approximately 27 mm. In some embodiments, the pouring channel 108 diverges from the throat to the distal end along a length of between approximately 15 mm to approximately 35 mm, between approximately 20 mm to approximately 32 mm, or between approximately 25 mm to approximately 30 mm. In other embodiments, the diverging section 115 may be longer or shorter depending on the size of the wine bottle and the aerator 100 and the characteristics of the fluid. Desirably, the diameter of the pouring channel 108 at the distal end 103 is approximately 10 mm. In some embodiments, a diameter of the pouring channel 108 at the distal end 103 may be between approximately 3 mm and approximately 25 mm, approximately 6 mm and approximately 17 mm, or approximately 8 mm and approximately 12 mm. The aeration passage 114 allows a surface area of wine passing through the pouring channel 108 to come in contact with oxygen in the air to improve the flavor of the wine.

Additionally, the air passage 106 in the aerator 100 allows air to pass into the bottle as the wine or other liquid is poured due to a vacuum effect. The additional air passage 106 allows more air to enter the bottle without inhibiting the aeration process and provides a more consistent pour rate.

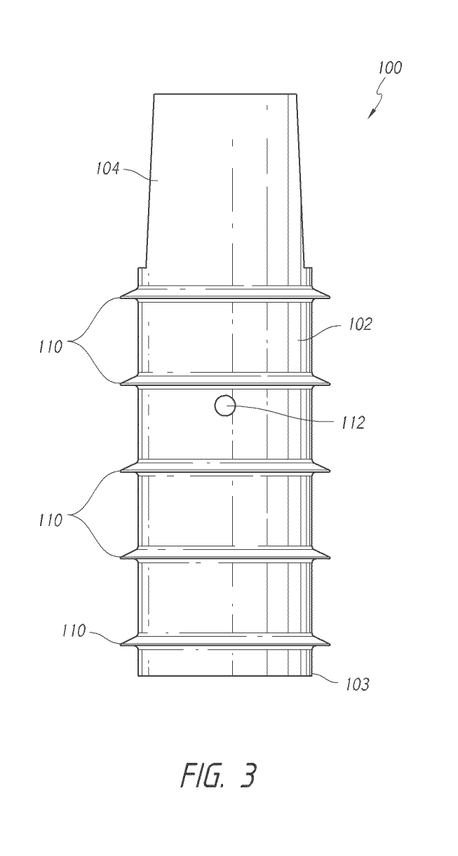

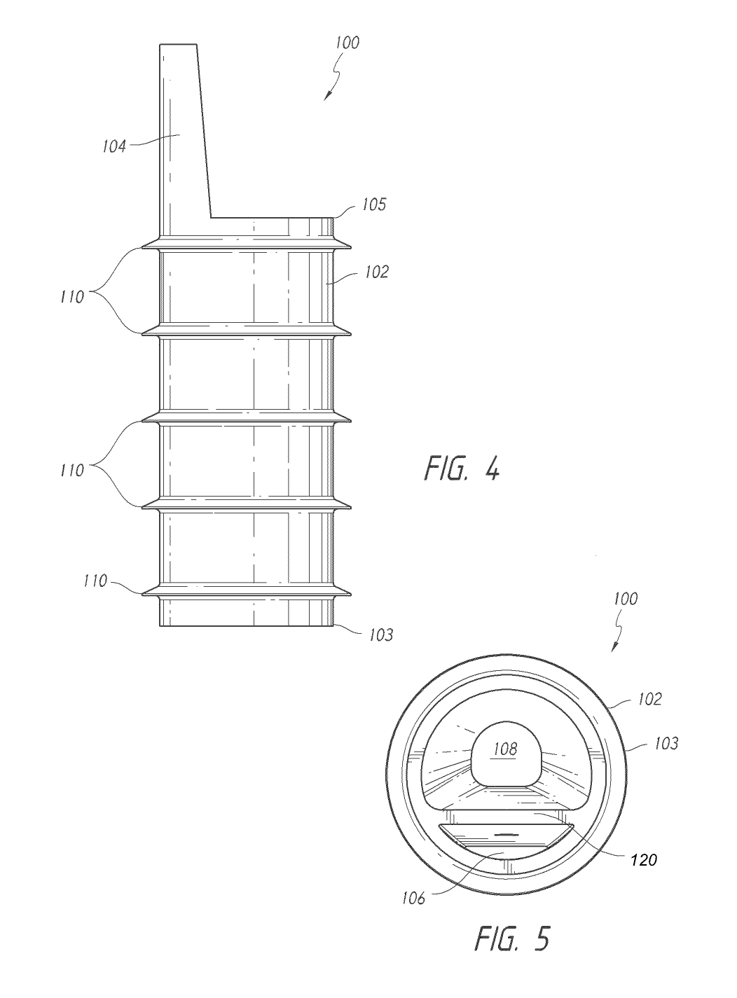

Two side plane views of the aerator 100 are shown in FIGS. 3 and 4. As illustrated, the opening 112 allows air to enter the passage 108 via the aeration passage.

With reference to FIG. 5, an end-on view of the aerator 100 from the proximal end 103 is illustrated. The pouring channel 108 is separated from the air passage 106 by a wall 120 that runs the length of the aerator 100, from the proximal end 103 to the distal end 105. As discussed above with respect to FIG. 2, the aeration passage 114 preferably bisects the air passage 106 and the wall 120 so that air can pass from the outside environment into the pouring channel 108 to mix with the fluid as it passes through the throat 116 of the aerator 100.

The aerator 100 is effective at aerating liquids because of the proportional dimensions of the converging and diverging sections of the pouring channel 108. This design gives the aerator 100 the flow rate and optimal oxygen mixing capabilities to effectively aerate liquids with comparable results to much larger aerators on the market. Incorporating aerator 100 into the bottle increases the ease of use of the aerator.

The aerator 100 is designed to fit into many standard glass wine bottles such as Burgundy and Bordeaux bottles currently used in the wine industry. It should be noted that many glass wine bottles vary in design but the dimensions of the bottleneck are similar and typically range from approximately 18-22 mm inside diameter. The rib members 110 allow flexibility to install the aerator 100 into a wide range of bottles.

In other embodiments, the aerator 100 may have a longer length and larger rib members such that the aerator 100 can fit larger diameter bottles. The dimensions of the aerator 100 may also be adjusted so that the aerator 100 can fit within the taps of wine kegs. In some embodiments, the aerator 100 can fit within bottles having traditional corks.

### Swirling Turbulence Design

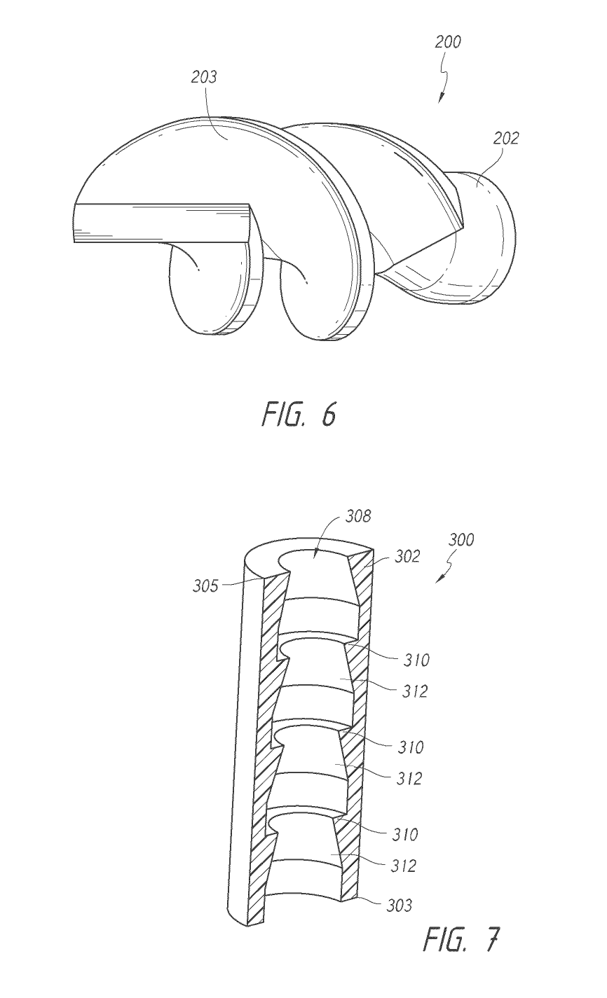

A second embodiment of an in-bottle aerator is illustrated in FIG. 6. In this embodiment, turbulent flow is induced by the shape of the aerator to induce the mixture of air with the fluid. The aerator 200 includes a body 202 having a cork-screw shape. The body 202 may be of varying diameters such that the body 202 can fit tightly within bottlenecks of varying diameters. The cork-screw shape of the body 202 directs fluid in a swirling motion along the curved surface 203 of the body 202. As the fluid travels from one end of the body to the other, the fluid is swirled around the body 202, resulting in turbulent flow. Turbulence or turbulent flow is characterized by rapid variation of pressure and velocity. The readily available supply of energy in turbulent flows tends to accelerate mixing or diffusivity of the fluid. Turbulent flow further creates eddies or swirls in which air can mix with or aerate the fluid. The aerator 200 is universal and can be inserted for flow in either direction.

### Tapered Turbulence Design

A third embodiment of an in-bottle aerator is illustrated in FIG. 7. The aerator 300 includes a cylindrical body 302. The cylindrical body 302 defines a pouring channel 308 that runs through the cylindrical body 302 from a proximal end 303 to a distal end 305. As discussed above with respect to the other embodiments, the body 302 may be of varying diameters such that the body 302 can fit tightly within bottlenecks of varying diameters. As fluid passes from the proximal end 303 to the distal end 305 of the pouring channel 308, the fluid passes over a plurality of ledges 310 created by the varying cross-section of the pouring channel 308 consisting of a plurality of converging sections 312. The fluid is initially accelerated as it passes through each converging section 312, lowering the pressure of the fluid. When the fluid passes over the ledges 310, the fluid is allowed to expand and decrease in velocity, increasing the pressure of the fluid and creating eddies or swirls in the flow. These eddies or swirls promote the mixing of air and oxygen with the fluid. The aerator 300 creates turbulence in the flow as the flow passes through the converging sections 312 and over the ledges 310, allowing oxygen to be mixed with the wine.

### Surface Area Model Design

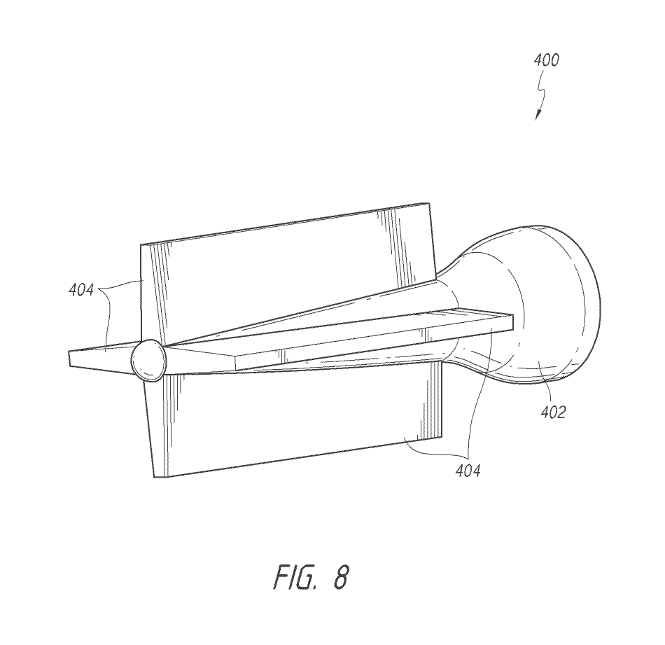

A fourth embodiment of an in-bottle aerator is illustrated in FIG. 8. The aerator 400 includes a tapered cylindrical body 402 with a plurality of wedges 404 oriented approximately every 90 degrees around the circumference of the body. Each of the wedges 404 extends along a length of the cylindrical body 402. Fluid passing over the wedges 404 is induced to mix with air. Wine flows from the tapered cylindrical body 402 to the plurality of wedges 404. This design aerates the liquid by increasing the surface area of wine in contact with oxygen.

### Finite Element and Compressive Stress Analysis of the Venturi Design

A compressive stress analysis was performed on the Venturi design. The analysis utilized the basic cylinder press fit principle: interference between an outer hollow cylinder and an inner full cylinder results in radial and hoop stresses on the inner cylinder. The aerator was press fit into the bottle neck, essentially deforming the silicon rubber seal and causing the surface to feel radial and hoop stresses. The glass inner diameter is defined as the minimum diameter of the bottle neck which serves as a conservative estimate of the stress. The main assumption during the compression analysis was that preferably only the seal deforms so the aerator body and glass bottleneck act as rigid bodies because the modulus of the glass and aerator is high relative to the silicon rubber.

A finite element analysis was also performed on the Venturi design. The analysis was used to analyze whether the aerator can uphold its structural integrity when acted on by the compressive load resulting from the press fit within the bottle neck. A radial pressure found from the compressive stress calculation is applied to the aerator, and the maximum deformation and stress points are found.

The compressive stress analysis used the following dimensions: glass inner diameter, aerator outer diameter (with seal), and the aerator diameter without the seal. The material properties for the seal are determined from the manufacturer's specification sheet. Equations 1 and 2 are used to calculate radial and hoop stress, respectively.

$$\begin{matrix}Radial p = \frac{δ}{R [ \frac{1}{{E}_{o}} ( \frac{{r}_{o}^{2} + {R}^{2}}{{r}_{o}^{2} - {R}^{2}} ) - {v}_{o} ) + \frac{1}{{E}_{i}} ( \frac{{r}_{i}^{2} + {R}^{2}}{{r}_{i}^{2} - {R}^{2}} - {v}_{i} )} & EQN . 1 \\ Hoop {( {σ}_{t} )}_{i} = - p * \frac{{R}^{2} + {r}_{i}^{2}}{{R}^{2} - {r}_{i}^{2}} & EQN . 2\end{matrix}$$

TABLE 1
Dimensions and Material Properties of Aerator and Bottle

| | | | | Equivalent |
|---|---|---|---|---|
| Component | | Value | | Variable |
| Inner Radius of bottle neck at | R_{glass} | 0.237 | in | R |
| smallest point | | | | |
| Radius of aerator without seal | Rₐₑᵣₐₜₒᵣ | 0.210 | in | rᵢ |
| Seal thickness | t | 0.0318 | in | — |
| Total Radius of aerator | Dₒ | 0.241 | in | — |
| Interference | δ | 0.0038 | in | δ |
| Length of aerator | L | — | — | L |
| Modulus of Silicon Rubber | Eᵢ | 90 | psi | Eᵢ |
| Poisson's Ratio of Silicon | νᵢ | 0.5 | — | νᵢ |
| Rubber | | | | |

The results are shown in Table 2. The results were used to conduct a finite element analysis on each aerator prototype.

TABLE 2
Compressive Stress Analysis Results

| | | |
|---|---|---|
| Radial Pressure on cylinder | p | 0.38 psi |
| Surface area of aerator | Aₛ | 1.52 in² |
| Equivalent force from radial stress | Fᵣ | 0.58 lb |
| Hoop stress | σₜ | 3.08 psi |
| Cross sectional area | A_{c} | 0.18 in² |
| equivalent force from hoop stress | Fₜ | 0.55 lb |

The FEA (Finite Element Analysis) was conducted using the software ABAQUS/CAE version 6.11-2. The aerator material is preferably acrylic so a Young's modulus of 1800 MPa and a Poisson's ratio of 0.35 were input. The external pressure load was 0.38 psi (2620.01 Pa).

For the first analysis, a 1 mm thick by 16.5 mm diameter cylinder made of a solid element was analyzed to simulate the worst case scenario wherein no internal structures support the outer shell. Boundary conditions were assigned to each end of the cylinder so that the cylinder didn't rotate or move along its center axis. The mesh elements were hexagonal with quadratic (no reduced integration) analysis and a 1 mm seed size. The maximum amount of experienced stress is 20,350 Pa which is far less than the material's yield strength of around 48 MPa.

A second Finite Element Analysis was performed on the Venturi style design. The Venturi design was meshed with triangular elements and a seed size of 1 mm. The inside of the mixing chamber was fixed in placed and considered rigid to provide ABAQUS with a boundary condition. The maximum deformation was found to be 0.00025 mm with a maximum stress of 54,600 Pa. These values are both far below failure conditions.

### Flow Rate Testing

The pour angle is a dominant variable when testing the flow rate of wine through aerators. Obviously, the typical wine pour involves someone pouring wine into a glass at a specific angle, which fluctuates constantly from glass to glass. An apparatus utilizing a constant pour angle was made in order to develop a consistent flow rate test. The apparatus tests the amount of time it takes to empty the volume of water out of a full wine bottle. The time can be calculated as an average flow rate, which accounts for pressure changes in the bottle throughout the process. Each aerator was tested at a 45 degree angle with the exception of the Soiree, which is preferably poured at a 90 degree angle in order to effectively function. The idea is to develop a baseline average flow rate to compare to the developed designs. Table 3 shows the times and flow rates for each aerator to empty a 750 ml bottle of wine.

TABLE 3
Time to Empty Bottle and Flow Rate for Various Designs

| | Time | Flow Rate |
|---|---|---|
| Aerator | (s) | (ml/s) |
| Control (w/o Aerator) | 8.13 | 92.3 |
| Soiree (90 degrees) | 59.38 | 12.6 |
| VinOAir | 40.05 | 18.7 |
| Rabbit | 61.38 | 12.2 |

The control scenario exhibited far lesser restriction of flow than the aerator scenarios. The control flow rate was greater than the aerator flow rates by a max factor of approximately 7.5. The magnitude of the control flow rate introduces a turbulent feel and unaesthetic look while pouring. The designed aerator preferably has a flow rate with a minimum of 9 ml/s (80 seconds to empty).

Flow rate testing was also performed with the Venturi design, as indicated by the following tables of results.

TABLE 4
Flow Rate Testing Results, Venturi Design, First Round
Flow Rate Testing, First Round (in milliliters per second)

| | RAir2.5 | RAir3.5 | UBig | USmall | UBigShort |
|---|---|---|---|---|---|
| 1 | 34.8 | 32.4 | 39.1 | 50.9 | 58.4 |
| 2 | 34.1 | 31.4 | 39 | 50.5 | 58.6 |
| 3 | 34.4 | 31.7 | 39.7 | 55.5 | 58.5 |
| 4 | 34.6 | 31.9 | 39.2 | 56.4 | 58.1 |
| 5 | 35.4 | 30.66 | 39.9 | 55.5 | |
| 6 | 35.5 | 31.4 | 39.8 | 55.4 | |
| Avg. | 34.8 | 31.58 | 39.45 | 54.03 | 58.4 |

Flow rate testing was conducted for multiple variations of the Venturi design illustrated in FIGS. 1-5. In each testing design, the diameter of the opening 112 varied to determine the effect on flow rates. Desirably, the Venturi design shown in FIGS. 1-5 allows liquid to flow through the aerator at approximately 50 milliliters per second.

TABLE 5
Flow Rate Testing Results, Second Round
Flow Rate Testing, Second Round (milliliters per second)

| | | | | | | |
|---|---|---|---|---|---|---|
| | | PL, no | PL, no | | | |
| | PW, 2 | back, | back, | Bell | | Bell |
| | small | small | big | spiral, | KK, | fins, 45 |
| Timer | holes | hole | hole | 45 deg | taper | deg |

| | | | | |
|---|---|---|---|---|
| 1 | The air holes were too small | 46.5 | 54 | 41.5 |
| 2 | on these designs to allow for | 46.5 | 53.7 | 41.9 |
| 3 | flow. The SA aerators | 01:42.3 | 56 | 43.3 |
| 4 | wouldn't flow at 90 degrees | 01:41.4 | 56.2 | 43.4 |
| 5 | like intended. | 02:00.4 | 55 | 42.1 |
| 6 | | 02:00.8 | 55.9 | 42.1 |
| | Average: | NA | 55.13 | 42.38 |

Additional flow rate testing was conducted on other variations of the Venturi design shown in FIGS. 1-5. As illustrated by the results shown above in Tables 4 and 5, the design illustrated in FIGS. 1-5 having a tapered pouring channel 108 results in the highest flow rate of 55.13 milliliters per second.

### Dissolved Oxygen Testing Results

Aerating wine essentially changes the sulfides and oxygen content within the fluid. Several methods can quantify aeration, including measuring the amount of dissolved oxygen within the fluid. A base measurement (control) needs to be established with each trial during the testing as the wine essentially begins aerating once the bottle is opened. The testing process involved testing the existing aerators by measuring the dissolved oxygen in the wine before and after the wine is poured. Each raw measurement is in units of parts per million (ppm) or mg/l, and the reduced data includes each aerator's average difference in dissolved oxygen before and after pouring. Table 6, below, illustrates the dissolved oxygen testing results.

TABLE 6
Dissolved Oxygen Test Results
Dissolved Oxygen (mg/L)

| Pour # | Tapered1 | Tapered2 | Spiral | VinOAir | | Rabbit |
|---|---|---|---|---|---|---|
| Control 1 | 2.41 | 3.54 | 0.65 | 3.43 | 4.57 | 0.92 |
| 1 | 2.9 | 3.93 | 1.2 | 3.88 | 4.79 | 1.85 |
| Control 2 | 2.58 | 3.72 | 1.04 | 3.61 | 4.64 | 1.01 |
| 2 | 3.07 | 4.18 | 1.6 | 4.02 | 4.95 | 2.00 |
| Control 3 | 3.04 | 3.99 | 1.49 | 3.99 | 4.78 | 1.40 |
| 3 | 3.57 | 4.55 | 2.26 | 4.57 | 5.21 | 2.48 |

The control results for each pour were taken before the wine was poured. As indicated by the results, the amount of dissolved oxygen increased for each pour from the initial control value. The Tapered 2 design exhibited the greatest amount of dissolved oxygen within the fluid, followed by the Tapered 1 design and the Spiral Design.

The dissolved oxygen tests were performed at room temperature with the same wine used for all tests. Two Venturi aerator designs similar to the embodiment shown in FIGS. 1-5 were tested, Tapered1 and Tapered2, along with the Spiral aeration design. Two commercially available aerators, the VinoAir and Rabbit were tested in comparison with the prototype designs. The results indicate the Tapered2 design works as well as the commercially available VinoAir. The spiral prototype and Rabbit only minimally oxygenated the wine.

### Clarifications Regarding Terminology

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. An aerator for use substantially within the neck of a bottle, comprising:
a body having a first end, a second end, and a pouring channel for egress of liquid from the bottle, the pouring channel varying in cross-sectional area from the first end to the second end, the pouring channel having a first cross-sectional area at the first end, a second cross-sectional area at an area intermediate the first end and the second end, the first cross-sectional area being larger than the second cross-sectional area;
an air passage channel substantially parallel to the pouring channel, the air passage channel configured to allow air to enter the bottle; and
an aerator channel configured to allow air to enter the pouring channel at the second cross-sectional area.

2. The aerator of claim 1 further comprising at least one flexible sealing surface on an exterior surface of the body such that the body can seal within a neck of the bottle and act as a stopper to prevent liquid from passing between the body and an interior surface of the bottle, the sealing surface having a diameter greater than an external diameter of the body.

3. The aerator of claim 2, wherein the diameter of the at least one flexible sealing surface is 20.5 mm and the external diameter of the body is 17 mm.

4. The aerator of claim 2, comprising five sealing surfaces.

5. The aerator of claim 2, wherein the aerator is made from one or more of silicone, acrylic, stainless steel, food-grade high-density polyethylene, and polypropylene.

6. The aerator of claim 1, wherein the air passage channel extends further into the bottle beyond one of the first and the second end of the body.

7. The aerator of claim 1, wherein the air passage channel has a smaller cross-sectional area than the first cross-sectional area of the pouring channel.

8. The aerator of claim 1, wherein the air passage channel has a diameter of 1 mm.

9. The aerator of claim 1, wherein the second cross-sectional area is a minimum cross-sectional area of the pouring channel.

10. The aerator of claim 1, wherein the aerator channel bisects the air passage channel.

11. The aerator of claim 9, wherein the aerator channel is substantially orthogonal to the pouring channel.

12. The aerator of claim 1, wherein a flow of liquid through the pouring channel is approximately 50 milliliters per second.

13. An aerator for use substantially within the neck of a bottle, comprising a body having a first end, a second end, a pouring channel for egress of liquid from the bottle, an air passage channel for ingress of air to the bottle, and an aerator channel for ingress of air to the pouring channel, the pouring channel having at least one converging section and at least one diverging section.

14. An aerator for use substantially within the neck of a bottle, comprising:
a body having a first end, a second end, and a pouring channel for egress of liquid from the bottle, the pouring channel varying in cross-sectional area from the first end to the second end, the pouring channel having a first cross-sectional area at the first end and tapering to a second cross-sectional area at a first point intermediate the first end and the second end, the second cross-sectional area at the first point transitioning without taper to a third cross-sectional area larger than the second cross-sectional area.

15. The aerator of claim 14, wherein the first cross-sectional area and the third cross-sectional area are approximately equal.

16. The aerator of claim 14, wherein the second cross-sectional area is a minimum cross-sectional area of the pouring channel.

17. The aerator of claim 16, further comprising an aerator channel passing through the body of the aerator from an external surface of the body to the pouring channel, the aeration channel intersecting the pouring channel at the second cross-sectional area.

18. The aerator of claim 14, further comprising at least one flexible sealing surface on an exterior surface of the body such that the body can seal within the neck of the bottle and act as a stopper to prevent liquid from passing between the body and an interior surface of the bottle, the sealing surface having a diameter greater than an external diameter of the body.

19. The aerator of claim 18, wherein the diameter of the at least one flexible sealing surface is 20.5 mm and the external diameter of the body is 17 mm.

20. The aerator of claim 18, wherein the aerator is made from one or more of silicone, acrylic, stainless steel, food-grade high-density polyethylene, and polypropylene.
